(19) United States
(12) Patent Application Publication
(10) Pub. No.: US 2007/0171579 A1
(43) Pub. Date: Jul. 26, 2007

(54) TUNNEL TYPE MAGNETIC DETECTION ELEMENT IN WHICH CRYSTAL ORIENTATION OF MAGNETIC LAYER AND BARRIER LAYER IS SELECTED AND MANUFACTURING METHOD THEREOF

(75) Inventors: Yosuke Ide, Niigata-ken (JP); Naoya Hasegawa, Niigata-ken (JP); Masamichi Saito, Niigata-ken (JP); Masahiko Ishizone, Niigata-ken (JP); Takuya Seino, Niigata-ken (JP); Ryo Nakabayashi, Niigata-ken (JP); Kazumasa Nishimura, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Toky (JP)

(21) Appl. No.: 11/625,147

(22) Filed: Jan. 19, 2007

(30) Foreign Application Priority Data
Jan. 20, 2006 (JP) 2006-012107

(51) Int. Cl. G11B 5/33; G11B 5/127

(52) U.S. Cl. 360/324.2

(57) ABSTRACT

Described herein is a tunnel type magnetic detection element and a manufacturing method thereof. In the tunnel type magnetic detection element, an enhance layer included in a free magnetic layer disposed on an insulating barrier layer contacts the insulating barrier layer, which may be made of an oxide such as titanium oxide. Under the insulating barrier layer, a second pinned magnetic layer constituting a pinned magnetic layer is formed. The second pinned magnetic layer has a fcc structure in which crystal planes equivalent to a (111) plane are aligned parallel to a layer surface, and the insulating barrier layer is formed to have a rutile structure or the like. The enhance layer is formed to have a bcc structure in which crystal planes equivalent to a (110) plane are aligned parallel to a layer surface.

This patent document claims the benefit of Japanese Patent Application No. 2006-012107 filed on Jan. 20, 2006, which is hereby incorporated by reference.

### TECHNICAL FIELD

The present disclosure relates to a tunnel type magnetic detection element for use in a hard disk device or as an MRAM (magnetic resistance memory), and more particularly, to a tunnel type magnetic detection element capable of decreasing a RA (element resistance R×element area A) value and increasing a resistance change ratio (ΔR/R) and a manufacturing method thereof.

### BACKGROUND

In patent documents including JP-A-2001-6130, JP-A-2001-6127, JP-A-2002-164590, JP-A-2005-228998, and JP-A-2004-6589, tunnel type magnetic detection elements are disclosed. The tunnel type magnetic detection element has a stacked layer structure including at least a pinned magnetic layer, a free magnetic layer, and an insulating barrier layer which is interposed between the fixed and free magnetic layers.

The pinned magnetic layer and the free magnetic layer are formed of magnetic materials including FeCo and NiFe (For example, in the 45^{th} paragraph of the patent document JP-A-2001-6130, in the 40^{th} paragraph of the patent document JP-A-2001-6127, and in the 35^{th} paragraph of the patent document JP-A-2002-164590).

However, in the tunnel type magnetic detection element, it is an object to decrease a RA (element resistance R×element area A) value and increase a resistance change ratio (ΔR/R).

As an example, by disposing a magnetic material layer which has a high spin polarization on a side contacting the insulating barrier layer, the resistance change ratio (ΔR/R) is expected to increase. As an example, a CoFe alloy has a higher spin polarization than a NiFe alloy.

The pinned magnetic layer, as an example, is formed to have a stacked layer ferri-structure which is formed by stacking a first pinned magnetic layer, a second pinned magnetic layer, and a non-magnetic intermediate layer which is interposed between the first and second pinned magnetic layers. The second pinned magnetic layer is contacted with the insulating barrier layer.

In addition, in the free magnetic layer, as disclosed in the 67^{th} paragraph of the patent document JP-A-2001-6130, a enhance layer, which has a high spin polarization, is arranged for example in a position contacting the insulating barrier layer (denoted as a tunnel barrier layer 30 in the patent document JP-A-2001-6130) (In the patent document JP-A-2001-6130, it was written that a ferromagnetic thin film layer which is formed of a spin polarization material having high electron conduction is interposed between a ferromagnetic free layer 20 and a tunnel barrier layer 30).

Under the aforementioned structure including the pinned magnetic layer and the free magnetic layer, layers which mainly contribute to the resistance change ratio (ΔR/R) are the second pinned magnetic layer in the pinned magnetic layer and the enhance layer in the free magnetic layer. Generally, the second pinned magnetic layer and the enhance layer are formed of a magnetic material having the same composition. For example, the second pinned magnetic layer and the enhance layer may be formed of Co_{90at.%}Fe_{10at.%}. In the 70^{th} paragraph of the patent document JP-A-2001-6130 or the 56^{th} paragraph of the patent document JP-A-2001-6127, it is disclosed that the enhance layer and the pinned magnetic layer are formed of Co.

However, in a general tunnel type magnetic detection element, when the RA value decreases, the resistance change ratio (ΔR/R) also decreases, and accordingly it was difficult to decrease the RA value together with increasing the resistance change ratio (ΔR/R). This fact is verified in an experiment to be described below.

### BRIEF SUMMARY

Provided herein is a tunnel type magnetic detection element that may be capable of decreasing an RA value and increasing a resistance change ratio (ΔR/R), and a manufacturing method thereof.

According to one aspect, the tunnel type magnetic detection element includes a lower magnetic layer, an insulating barrier layer, and an upper magnetic layer sequentially stacked from below. One of the magnetic layers forms at least a portion of a pinned magnetic layer having a fixed magnetization, and the other magnetic layer forms at least a portion of a free magnetic layer having a magnetization that varies in accordance with an external magnetic field. At least a part of the lower magnetic layer has a face centered cubic structure in which crystal planes equivalent to a (111) plane are aligned parallel to a layer surface. At least a part of the insulating barrier layer has one of an amorphous structure, a body centered cubic structure, a body centered tetragonal structure, and a rutile structure, and at least a part of the upper magnetic layer has a body centered cubic structure in which crystal planes equivalent to a (110) plane are aligned parallel to a layer surface.

According to another aspect, there is provided a method of manufacturing a tunnel type magnetic detection element including the following steps of:

(a) forming an upper magnetic layer, wherein at least a part of the upper magnetic layer has a face centered cubic structure in crystal planes equivalent to a (111) surface are aligned parallel to a layer surface;

(b) forming an insulating barrier layer on the lower magnetic layer, wherein at least a part of the insulating barrier layer has one of an amorphous structure, a body centered cubic structure, a body centered tetragonal structure, or a rutile structure; and

(c) forming an upper magnetic layer on the insulating barrier layer, wherein at least a part of the upper magnetic layer has a body centered cubic structure in which crystal planes equivalent to a (110) plane are aligned parallel to a layer surface.

### BRIEF DESCRIPTION OF THE DRAWINGS

FIG. 1 is a sectional view of a read head including a tunnel type magnetic resistance effect element according to one embodiment, where the sectional view is taken along a plane parallel to a surface facing a recording medium.

FIG. 2 is a sectional view of a read head including a tunnel type magnetic resistance effect element according to another embodiment, where the sectional view is taken along a plane parallel to a surface which faces a recording medium.

FIG. 3 is a schematic diagram of a face centered cubic structure viewed from a {111} equivalent plane.

FIG. 4 is a schematic diagram showing a crystal structure of titanium oxide.

FIG. 5 is a schematic diagram of a body centered cubic structure viewed from a {110} equivalent plane.

FIG. 6 is a graph showing the relationship between the RA value and the resistance change ratio (ΔR/R) of each one of tunnel type magnetic detection elements according to embodiments 1 and 2 in which the Fe composition ratio of the enhance layer formed on the insulating barrier layer is greater than that of the second pinned magnetic layer formed under the insulating barrier layer and according to a comparison example 1 in which the Fe composition ratios of the enhance layer and the second pinned magnetic layer are the same.

FIG. 7 is a graph showing the relationship between the Fe composition ratio y of an enhance layer which is formed on an insulating barrier layer and the RA value.

FIG. 8 is a graph showing the relationship between the Fe composition ratio y of the enhance layer which is formed on the insulating barrier layer and the resistance change ratio (ΔR/R).

FIG. 9 is a graph showing the resistance change ratio (ΔR/R) of each one of tunnel type magnetic detection elements according to embodiments 1 and 2 (where the composition ratios of Ni in the soft magnetic layer are different between the embodiment 1 and 2) in which the Fe composition ratio of the enhance layer formed on the insulating barrier layer is greater than that of the second pinned magnetic layer formed under the insulating barrier layer and according to a comparison example 1 in which the Fe composition ratios of the enhance layer and the second pinned magnetic layer are the same.

FIG. 10 is a graph showing magnitudes of magnetostriction of the embodiments 1 and 2 and the comparison example 1.

### DETAILED DESCRIPTION

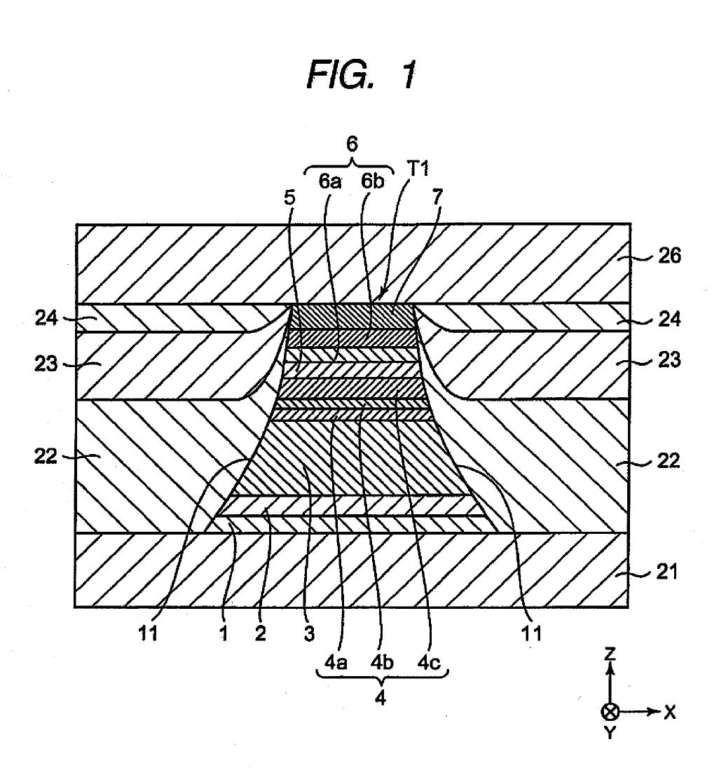

FIG. 1 is a sectional view of a read head including a tunnel type magnetic resistance effect element according to one embodiment taken along a plane parallel to a surface facing a recording medium.

The tunnel type magnetic resistance effect element is disposed, for example, on an end portion of a trailing side of a levitation type slider included in a hard disk device to detect a recorded magnetic field on a hard disk or the like. In the figure, a direction X is a track width direction, a direction Y is a direction of a leakage magnetic field from a magnetic recording medium (height direction), and a direction Z is a moving direction of a magnetic recording medium including a hard disk and a stacking direction of each layer of the tunnel type magnetic resistance effect element.

A bottom shield layer 21 formed of a NiFe alloy, is formed in a lowest position in FIG. 1. On the bottom shield layer 21, a stacked layer body T1 is formed. In addition, the tunnel type magnetic resistance effect element includes a lower insulating layer 22, a hard bias layer, and an upper insulating layer 24 which are formed on both sides of the stacked layer body T1 in a track widthwise direction (the direction X) along with the stacked layer body T1.

The lowest layer of the stacked layer body T1 is a base layer 1 which may be formed of a non-magnetic material including one or more elements selected from among Ta, Hf, Nb, Zr, Ti, Mo, and W. On the base layer 1, a seed layer 2 is formed. The seed layer 2 is formed of NiFeCr or Cr.

An anti-ferromagnetic layer 3 which is formed on the seed layer 2 is formed of an anti-ferromagnetic material containing an element α (where α is one or more elements selected from among Pt, Pd, Ir, Rh, Ru, and Os) and Mn or an anti-ferromagnetic material containing elements α, \acute{α} (where \acute{α} is one or more elements selected from among Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and rare-earth elements), and Mn. For example, the anti-ferromagnetic layer 3 may be formed of IrMn or PtMn.

On the anti-ferromagnetic layer 3, a pinned magnetic layer 4 is formed. The pinned magnetic layer 4 has a stacked layer ferri-structure in which a first pinned magnetic layer 4a, a non-magnetic intermediate layer 4b, and a second pinned magnetic layer 4c are stacked sequentially from the bottom. The magnetization directions of the first and second pinned magnetic layers 4a and 4c become anti-parallel to each other due to an exchange coupled magnetic field on a boundary surface with the anti-ferromagnetic layer 3 and an anti-ferromagnetic exchange coupled magnetic field (RKKY interaction) through the non-magnetic intermediate layer 4b. This is called a stacked layer ferri-structure. By using the stacked layer ferri-structure, magnetization of the pinned magnetic layer 4 may be in a stable state, and an apparent exchange coupled magnetic field generated from a boundary surface between the pinned magnetic layer 4 and the anti-ferromagnetic layer 3 may increase.

The first pinned magnetic layer 4a may be formed of a ferromagnetic material such as CoFe, NiFe, or CoFeNi. The non-magnetic intermediate layer 4b may be formed of a non-magnetic conductive material such as Ru, Rh, Ir, Cr, Re, or Cu. The second pinned magnetic layer 4c will be described later.

An insulating barrier layer 5 which is formed on the pinned magnetic layer 4 may be formed of an insulating oxide. The insulating barrier layer 5 may be formed of a titanium oxide (Ti—O), preferably. For example, the insulating barrier layer 5 may be formed of titanium dioxide (TiO₂).

On the insulating barrier layer 5, a free magnetic layer 6 is formed. The free magnetic layer 6 includes a soft magnetic layer 6b formed of a magnetic material such as a NiFe alloy and an enhance layer 6a formed between the soft magnetic layer 6b and the insulating barrier layer 5. The soft magnetic layer 6b may be formed of a magnetic material which has a superior soft magnetic property, preferably. The enhance layer 6a may be formed of a magnetic material which has a higher spin polarization than that of the soft magnetic layer 6b.

A track width Tw is determined as a width value of the free magnetic layer 6 in a track widthwise direction (direction X).

On the free magnetic layer 6, a protective layer 7, which is formed of a non-magnetic conductive material such as Ta, is formed.

As shown in FIG. 1, sides 11 and 11 of the stacked layer body T1 in a track widthwise direction (direction X) are formed as inclined surfaces in which a width between the sides 11 and 11 in the track widthwise direction gradually decreases upward from the bottom.

As shown in FIG. 1, the lower insulating layer 22 is formed on portions of the lower shield layer 21 extending from under the stacked layer body T1 and on the side portions 11 of the stacked layer body T1. In addition, on the lower insulating layer 22, the hard bias layer 23 is formed, and on the hard bias layer 23, the upper insulating layer 24 is formed.

Between the lower insulating layer 22 and the hard bias layer 23, a bias base layer (not shown) may be formed. The bias base layer may be formed of, for example, Cr, W, or Ti.

The insulating layers 22 and 24 are formed of insulating materials such as Al₂O₃ or SiO₂. In order to suppress a divided flow of a current which flows in a direction perpendicular to boundary surfaces of layers in the stacked layer body T1 into the sides of the stacked layer body T1 in the track widthwise direction, the top and bottom of the hard bias layer 23 is insulated. The hard bias layer 23 may be formed of, for example, a Co—Pt (cobalt-platinum) alloy, a Co—Cr—Pt (cobalt-chrome-platinum), or the like.

On the stacked layer body T1 and the upper insulating layer 24r an upper shield layer 26, which may be formed of a NiFe alloy or the like, is formed.

In the embodiment shown in FIG. 1, the lower shield layer 21 and the upper shield layer 26 serve as electrode layers of the stacked layer body T1, and a current flows in a direction perpendicular to surfaces of the layers of the stacked layer body T1 (direction parallel to the direction Z).

The free magnetic layer 6 is magnetized in a direction parallel to the track widthwise direction (direction X) by a bias magnetic field from the hard bias layer 23. The first and second pinned magnetic layers 4a and 4c which constitute part of the pinned magnetic layer 4 are magnetized in a direction parallel to the height direction (direction Y). Since the pinned magnetic layer 4 has a stacked layer ferri-structure, the first and second magnetic layers 4a and 4c are magnetized as anti-parallel, respectively. While the magnetization of the pinned magnetic layer 4 is fixed or pinned (the magnetization is not changed by an external magnetic field), the magnetization of the free magnetic layer 6 may be changed by an external magnetic field.

If the magnetization of the free magnetic layer 6 is changed by an external magnetic field when magnetizations between the second pinned magnetic layer 4c and the free magnetic layer 6 are anti-parallel, it becomes difficult for a tunnel current to flow through the insulating barrier layer 5 which is disposed between the second pinned magnetic layer 4c and the free magnetic layer 6. Accordingly, in this case it is possible to maximize a resistance. To the contrary, when the magnetizations between the second pinned magnetic layer 4c and the free magnetic layer 6 are parallel, it becomes easy for the tunnel current to flow. Accordingly the resistance may be minimized.

Using this principle, a leakage magnetic field from a recording medium may be detected as a change in voltage when an external magnetic field alters the magnetization of the free magnetic layer 6 and thus the electrical resistance of the device.

A technical aspect of the embodiment shown in FIG. 1 will now be described. The second pinned magnetic layer (lower magnetic layer) 4c constituting the pinned magnetic layer 4 shown in FIG. 1 is formed to contact the bottom surface of the insulating barrier layer 5. The enhance layer (upper magnetic layer) 6a constituting the free magnetic layer (upper magnetic layer) 6 is formed to contact the top surface of the insulating barrier layer 5. The second pinned magnetic layer 4c, the insulating barrier layer 5, and the enhance layer 6a are configured to affect the resistance change ratio (ΔR/R).

In the embodiment, at least a part of the second pinned magnetic layer 4c, which is formed under the insulating barrier layer 5, is formed to have a face centered cubic (fcc) structure in which crystallographic planes equivalent to a (111) plane of the fcc structure may be aligned parallel to a layer surface (X-Y surface). Included among the equivalent crystal planes that are part of the {111} family of crystallographic planes are (111), (−111), (1−11), (11−1), (−1−11), (−11−1), (1−1−1), and (−1−1−1) planes, as represented by their Miller indices.

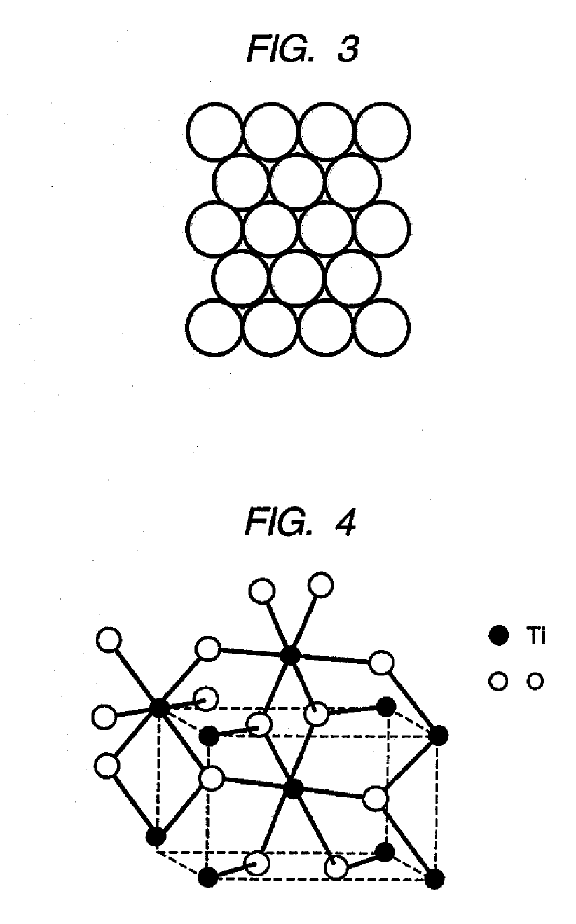

FIG. 3 is a schematic diagram of a face centered cubic structure viewed from a (111) or equivalent plane. Crystal planes corresponding to the {111} family of planes of the fcc structure have a highest atomic packing density. Accordingly, it is difficult for oxygen or the like to penetrate the insulating barrier layer 5 to reach the second pinned magnetic layer 4c, and accordingly, oxidation or deterioration of the second pinned magnetic layer may be prevented or minimized.

In this embodiment, the second pinned magnetic layer 4c may be formed of Co₁₀₀₋ₓFeₓ (where the Fe composition ratio X is in the range from 0 at. % to about 20 at. %), preferably. By adjusting the Fe composition ratio of the second pinned magnetic layer in this range, the second pinned magnetic layer 4c can be formed to have a face centered cubic (fcc) structure in which crystal planes equivalent to a (111) plane of the fcc structure are aligned in a direction parallel to a layer surface.

As described above, when the second pinned magnetic layer 4c is formed of a CoFe alloy, the Fe composition ratio x is configured to be low. Here, since an Fe oxide has a low standard free energy of formation when the standard free energies for forming a Co oxide and an Fe oxide are compared, Fe can be more easily oxidized than Co. However, by configuring the Fe composition ratio x to be low for acquiring a face centered cubic structure, the effect of oxidation may be weakened, and, accordingly, the spin polarization of the second pinned magnetic layer 4c may be improved.

In addition, when the second pinned magnetic layer 4c is in a state in which oxidation may occur readily, oxygen inside the insulating barrier layer 5 may be easily attracted toward the second pinned magnetic layer 4c, and accordingly a gradient of an amount of the oxygen can be present in the insulating barrier layer 5. However, in this embodiment, since the second pinned magnetic layer 4c is designed to be resistant to oxidation, the gradient of the amount of the oxygen inside the insulating barrier layer can be minimized.

Next, at least a part of the insulating barrier layer 5 may have one structure or two or more mixed structures among an amorphous structure, a body centered cubic (bcc) structure, a body centered tetragonal structure, or a rutile structure, preferably. When the insulating barrier layer 5 is formed of Ti—O, Sn—I, P—O, V—O, Nb—O, Mn—O, Ni—F, or Mg—F, the insulating barrier layer 5 may have a rutile structure. FIG. 4 shows the rutile structure. As an example, in a case of titanium dioxide, titanium (Ti) has a body centered cubic structure as shown in FIG. 4.

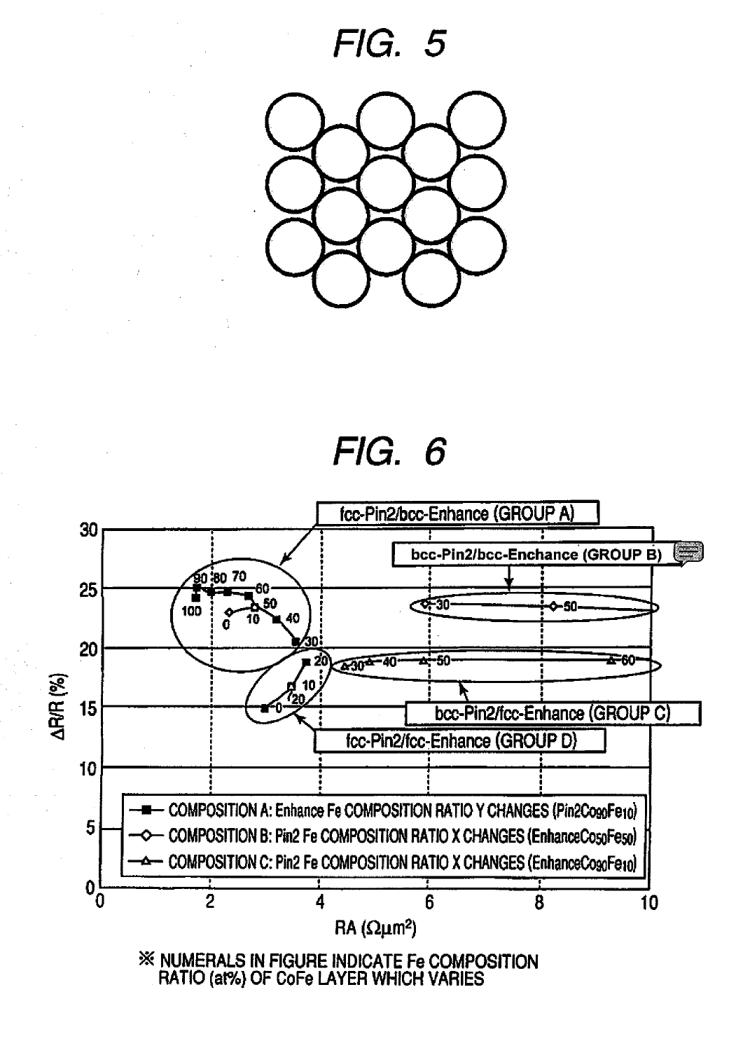

Next, at least a part of the enhance layer 6a has a body centered cubic (bcc) structure in which crystal planes equivalent to a (110) plane of the bcc structure are aligned parallel to a layer surface (X-Y surface). Included among equivalent crystal planes which are part of the {110} family of planes are (110), (−110), (1−10), (01−1), and (0−1−1) planes, as represented by their Miller indices. FIG. 5 is a schematic diagram of a body centered cubic structure viewed from a (110) or equivalent plane.

The {110} planes have a highest atomic packing density in the body centered cubic structure and thus may suppress oxygen, Ti, or the like from diffusing from the insulating barrier layer 5 into the enhance layer 6a. Accordingly, it may be possible to prevent a decrease in the spin polarization due to diffusion of oxygen during annealing or the like, although the enhance layer 6a is formed to have a Fe composition ratio which can increase the spin polarization. This advantage can come about whether the insulating barrier layer 5 has a crystalline structure or an amorphous structure.

As described above, when at least a part of the insulating barrier layer 5 is formed to have a body centered cubic structure, a body centered tetragonal structure, or a rutile structure and at least a part of the enhance layer 6a, which is formed on the insulating barrier layer 5, is formed to have a body centered cubic structure in which crystal planes equivalent to a (110) plane of the bcc structure are aligned parallel to a layer surface, lattice matching at the boundary between the insulating barrier layer 5 and the enhance layer 6a may be improved, and the enhance layer 6a may have excellent crystallinity. Accordingly, the spin polarization of the enhance layer 6a can improve. In addition, it is believed that the aforementioned advantage may be achieved although the insulating barrier layer 5 is amorphous or the like when at least a small part of the amorphous structure has an ordered atom arrangement of the body centered cubic structure or the rutile structure.

The enhance layer 6a which is formed on the insulating barrier layer 5 may be formed of Co_{100-y}Fe_{y} (where the Fe composition ratio y is in the range of from about 30 at. % to about 100 at. %), Co₂FeAl, Co₂FeSi, Co₂FeGa, Co₂FeGe, or Co₂Cr_{0.6}Fe_{0.4}Al, preferably. Accordingly, the enhance layer 6a can be formed to have a body centered cubic structure in which crystal planes equivalent to a (110) plane of the bcc structure are aligned in a direction parallel to a layer surface.

However, the Fe composition ratio y of the enhance layer 6a when the enhance layer 6a is formed of a CoFe alloy is higher than the Fe composition ratio x of the second pinned magnetic layer 4c when the second pinned magnetic layer 4c, which is formed under the insulating barrier layer 5, is formed of a CoFe alloy. Accordingly, the second pinned magnetic layer 4c can be formed to have a face centered cubic structure and the enhance layer 6a can be formed to have a body centered cubic structure, appropriately. As described above, when the enhance layer 6a is formed of a CoFe alloy, the Fe composition ratio y may be high. However, although the Fe composition ratio y is designed to be high, it may be difficult for the enhance layer 6a, which is formed on the insulating barrier layer 5, to undergo oxidation or the like in a process for forming the insulating barrier layer 5. Accordingly, the enhance layer 6a may be formed of a magnetic material which has a high polarization regardless of the effect of the oxidation or the like, unlike the second pinned magnetic layer 4c, which is formed under the insulating barrier layer 5.

In addition, when the insulating barrier layer 5 is formed of an insulating oxide material which is generated by forming a metal layer or a semiconductor layer and oxidizing the metal layer or the semiconductor layer, a boundary surface of the second pinned magnetic layer 4c with the insulating barrier layer receives an effect of the oxidation. However, by designing the Fe ratio of the enhance layer 6a, which is formed on the insulating barrier layer 5, to be higher than the Fe composition ratio of the second pinned magnetic layer 4c, which is formed under the insulating barrier layer 5, it is thought that oxygen around the boundary surface of the second pinned magnetic layer 4c with the insulating barrier layer 5 is attracted toward the enhance layer 6a (that is, an area around the boundary surface of the second pinned magnetic layer 4c is deoxidized) to decrease the amount of the oxygen around the boundary surface of the second pinned magnetic layer 4c.

As described above, the spin polarizations of the second pinned magnetic layer 4c and the enhance layer 6a can improve appropriately to make it possible to decrease the RA (where R is a resistance of an element and A is an area of an element) value together with increasing the resistance change ratio (ΔR/R).

The insulating barrier layer 5 may have a rutile structure, preferably. Specifically, the insulating barrier layer 5 may be formed of titanium dioxide, preferably. When the insulating barrier layer 5 is formed of titanium dioxide, the dominant crystal structure of the insulation barrier layer 5 becomes a rutile structure which has a high thermal stability. As described with reference to FIG. 4, when one element (titanium in titanium dioxide) constituting the rutile structure has a body centered tetragonal structure and the enhance layer 6a having a body centered cubic structure is formed on the insulating barrier layer 5, which is formed to have the rutile structure, it is possible to improve the lattice matching at the boundary between the insulating barrier layer 5 and the enhance layer 6a appropriately. When a material having the rutile structure, especially titanium oxide, is selected as the insulating barrier layer 5, as is shown by the experiment to be described later, it is possible to decrease the RA value together with increasing the resistance change ratio (ΔR/R) more effectively. The insulating barrier layer 5 may be a mixed structure of one or more structures selected among an amorphous structure, a body centered cubic structure, a body centered tetragonal structure, and a rutile structure and a different crystal structure. In addition, a part of the insulating barrier layer 5 may be amorphous.

When the enhance layer 6a which is formed on the insulating barrier layer 5 is formed of an CoFe alloy, the Fe composition ratio x may be adjusted in the range of from about 30 at. % to 100 at. %, preferably, as described above. In addition, it is more preferable to configure the Fe composition ratio y to be in the range of from about 50 at. % to 100 at. %, and even more preferable to configure the Fe composition ratio y to be in the range of from about 70 at. % to 100 at. %. By increasing a lowest value of the Fe composition ratio as described above, it is known that decreasing the RA value together with increasing the resistance change ratio (ΔR/R) can be done more effectively.

Alternatively, the enhance layer 6a, which is formed on the insulating barrier layer 5, may be formed of a Heusler alloy such as Co₂FeAl. The Heusler alloy is a metal having a high spin polarization and a half metal in which most of the conduction electrons are either up spin electrons or down spin electrons. By using the Heusler alloy for the enhance layer 6a, the resistance change ratio (ΔR/R) may be further increased.

Next, the soft magnetic layer 6b constituting the free magnetic layer 6 may be preferably formed of a NiFe alloy to improve a soft magnetic property of the soft magnetic layer 6b. As an experiment to be described later indicates, when the enhance layer 6a, which is formed on the insulating barrier layer 5, is formed of Co_{90at.%}Fe_{10at.%}, and when the soft magnetic layer 6b is formed of Ni_{81.5at.%}Fe_{18.5at.%}, as an example, the resistance change ratio (ΔR/R) can improve, compared with a case where the enhance layer 6a is formed of Co_{90at.%} Fe_{10at.%} and the soft magnetic layer 6b is formed of Ni_{81.5at.%}Fe_{18.5at.%}. However, there is a problem in that an absolute value of magnetostriction λ of the free magnetic layer 6 is increased. Accordingly, it is preferable to appropriately select the material of the soft magnetic layer 6b having a sign of magnetostriction opposite to a sign of the enhance layer 6a for decreasing an absolute value of the magnetostriction of the free magnetic layer 6. As an example, as described above, when the enhance layer 6a, which is formed on the insulating barrier layer 5, is formed of a CoFe alloy, the composition ratio of Fe is configured to be equal to or greater than about 30 at. %. However, as the composition ratio of Fe increases, the magnetostriction becomes a positive value, and accordingly, it is preferable that a soft magnetic material having a negative magnetostriction is used for the soft magnetic layer 6b.

When the enhance layer 6a is formed of a CoFe alloy and the soft magnetic layer 6b is formed of Ni_{z}Fe_{100-z}, the Ni composition ratio z may be greater than about 81.5 at. % and equal to or smaller than 100 at. % preferably. By adjusting the Ni composition ratio as described above, an absolute value of the magnetostriction of the free magnetic layer 6 may be decreased.

Alternatively, a structure in which a soft magnetic layer formed of Ni_{z}Fe_{100-z} having the Ni composition ratio z greater than about 81.5 at. % and equal to or less than 100 at. % is interposed between a soft magnetic layer 6b having a general composition and the enhance layer 6a may be used.

In addition, for composition analysis, a nano-beam energy-dispersive X-ray (Nano-beam EDX) spectroscopy using a SIMS analysis apparatus or a field emission transmission electron microscope (FE-TEM) or the like may be used.

In FIG. 1, the entire second pinned magnetic layer 4c which is formed under the insulating barrier layer 5 may be formed as a lower magnetic layer, according to this embodiment. Alternatively, the second pinned magnetic layer 4c may have a stacked layer structure of magnetic layers and at least one magnetic layer among the magnetic layers which contacts the insulating barrier layer 5 may be formed as the lower magnetic layer 4, according to the present embodiment. And also, the structure of the pinned magnetic layer 4 is not limited to the stacked layer ferri-structure shown in FIG. 1 and may include a single layer structure of a magnetic layer or a stacked structure of magnetic layers. In this case, the lower magnetic layer according to the present embodiment may be provided as the entire pinned magnetic layer 4 or a part thereof (at least a magnetic layer which contacts the insulation barrier layer 5).

In FIG. 1, although the entire enhance layer 6a, which is formed on the insulating barrier layer 5, is formed as an upper magnetic layer according to the present embodiment, the enhance layer 6a may be formed as a stacked layer structure of magnetic layers, and at least a magnetic layer which contacts the insulating barrier layer 5 may be formed as an upper magnetic layer according to one embodiment. Alternatively, the enhance layer 6a may not be included in the free magnetic layer 6, and the structure of the free magnetic layer is not limited to a structure shown in FIG. 1. In addition, the enhance layer 6a preferably has a higher spin polarization than that of the soft magnetic layer 6b and may prevent at least one element (Ni when formed of NiFe) which constitutes the soft magnetic layer 6b from penetrating into the insulating barrier layer 5. The enhance layer 6a may not be formed. In conclusion, the entire or a part of the free magnetic layer 6 (at least a magnetic layer which contacts the insulating barrier layer 5) is to be formed as the upper magnetic layer according to the present embodiment.

In the embodiment shown in FIG. 1, the pinned magnetic layer 4 is formed under the insulating barrier layer 5, and the free magnetic layer 6 is formed on the insulating barrier layer 5. However, in a case where the free magnetic layer 6 is formed under the insulating barrier layer 5, and the pinned magnetic layer 4 is formed on the insulating barrier layer 5, more specifically, when a soft magnetic layer 6b, an enhance layer 6a, an insulating barrier layer 5, a second pinned magnetic layer 4c, a non-magnetic intermediate layer 4b, and a first pinned magnetic layer 4a are sequentially stacked from the bottom, at least a part of the enhance layer 6a (lower magnetic layer) may have a face centered cubic structure in which crystal planes equivalent to a (111) plane are aligned parallel to a layer surface. Also, at least a part of the second pinned magnetic layer may have a body centered cubic structure in which crystal planes equivalent to a (110) plane of the bcc structure are aligned parallel to a layer surface. In other words, when a structure having a reverse structure of FIG. 1 is used, the enhance layer 6a, which is formed under the insulating barrier layer 5, may have the same composition or crystal structure as the second pinned magnetic layer 4c shown in FIG. 1, and the second pinned magnetic layer 4c, which is formed on the insulating barrier layer 5, may have the same composition or crystal structure as the enhance layer 6a shown in FIG. 1.

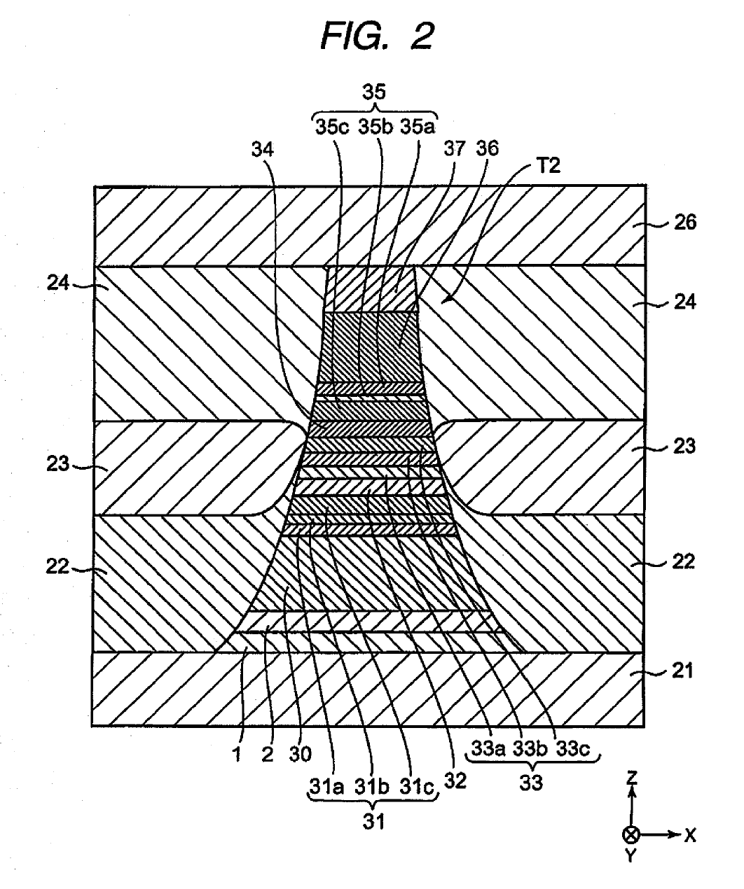

FIG. 2 is a sectional view of a read head including a tunnel type magnetic resistance effect element according to a second embodiment taken along a plane parallel to a surface which faces a recording medium. A layer having a same reference numeral as in FIG. 1 represents a same layer as in FIG. 1.

In FIG. 2, the tunnel type magnetic detection element is formed as a dual type. In other words, the stacked layer body T2 constructing the tunnel type magnetic detection element has a structure in which a base layer 1, a seed layer 2, a lower anti-ferromagnetic layer 30, a lower pinned magnetic layer 31, a lower insulating barrier layer 32, a free magnetic layer 33, an upper insulating barrier layer 34, an upper pinned magnetic layer 35, an upper anti-ferromagnetic layer 36, and a protection layer 37 are stacked sequentially from the bottom.

The lower pinned magnetic layer 31 has a stacked layer ferri-structure in which a lower first pinned magnetic layer 31a, a lower non-magnetic intermediate layer 31b, and a lower second pinned magnetic layer 31c are sequentially stacked from the bottom.

The upper pinned magnetic layer 35 has a stacked layer ferri-structure in which an upper second pinned magnetic layer 35c, an upper non-magnetic intermediate layer 35b, and an upper first pinned magnetic layer 35a are sequentially stacked from the bottom.

The free magnetic layer 33 has a stacked layer structure in which an enhance layer 33a, a soft magnetic layer 33b, and an enhance layer 33c are sequentially stacked.

In the embodiment shown in FIG. 2, two insulating barrier layers 32 and 34 are formed. Accordingly, the crystal structure of magnetic layers which are formed on/under the insulating barrier layer 32 and 34 may be controlled appropriately. In addition, at least a part of the insulating barrier layer 32 and 34 may have a body centered cubic structure, a body centered tetragonal structure, or a rutile structure.

At least a part of the lower second pinned magnetic layer 31c (lower magnetic layer) which is formed under the lower insulating barrier layer 32, is formed to have a face centered cubic structure in which crystal planes equivalent to a (111) plane of the fcc structure are aligned parallel to a layer surface.

At least a part of the enhance layer 33a (upper magnetic layer) which is a lowest layer of the free magnetic layer 33 formed on the lower insulating barrier layer 32 is formed to have a body centered cubic structure in which crystal planes equivalent to a (110) plane of the bcc structure are aligned parallel to a layer surface.

Next, at least a part of the enhance layer 33c (lower magnetic layer) which is a highest layer of the free magnetic layer 33 formed under the upper insulating barrier layer 34 is formed to have a face centered cubic structure in which crystal planes equivalent to (111) plane of the fcc structure are aligned parallel to a layer surface.

In addition, at least a part of the upper second pinned magnetic layer 35c (upper magnetic layer) which is formed on the upper insulating barrier layer 34 is formed to have a body centered cubic structure in which crystal planes equivalent to a (110) plane of the bcc structure are aligned parallel to a layer surface.

By using the aforementioned structure, it is possible to decrease the RA value and increase the resistance change ratio (ΔR/R).

The enhance layer 33a and the upper second pinned magnetic layer 35c which are formed on the insulating barrier layers 32 and 34, respectively, shown in FIG. 2, may be formed to have the same composition as the enhance layer 6a described in FIG. 1, preferably. The enhance layer 33c and the lower second pinned magnetic layer 31c which are formed under the insulating barrier layers 32 and 34, respectively, may be formed to have the same composition as the second pinned magnetic layer 4c described in FIG. 1, preferably.

A method of manufacturing a tunnel type magnetic detection element according to one embodiment will now be described. Please refer to the description of the materials of the layers, since the method is described with reference to FIG. 1.

In the embodiment shown in FIG. 1, the base layer 1, the seed layer 2, the anti-ferromagnetic layer 3, the first pinned magnetic layer 4a, the non-magnetic intermediate layer 4b, and the second pinned magnetic layer 4c are continuously formed on the lower shield layer 21 through a sputtering process in a same vacuum space.

Next, in the same vacuum space, on the second pinned magnetic layer 4c, a metal layer or a semiconductor layer is formed by sputtering.

Here, when the insulating barrier layer 5 shown in FIG. 1 is formed of titanium oxide, a titanium layer is formed on the second pinned magnetic layer 4c using a Ti sputtering target. Then, the insulating barrier layer 5 which is formed of titanium oxide is formed by oxidizing the titanium layer by natural oxidation, radical oxidation, ion oxidation, plasma oxidation, or the like.

Next, on the insulating barrier layer 5, the enhance layer 6a, the soft magnetic layer 6b, and the protection layer 7 are continuously formed by a sputtering process in the same vacuum space.

After stacking the layers up to the protection layer 7, a thermal process in a magnetic field is performed. The magnetic field is applied in a height direction (direction Y) As a result, the magnetizations of the first and second pinned magnetic layers 4a and 4c which constitute the pinned magnetic layer can be pinned in a direction parallel to a height direction and in opposite directions from each other.

As shown in FIG. 1, an etching process for forming the stacked layer body T1 into an approximate trapezoid shape of which a width in a track widthwise direction (direction X) gradually decreases upward from the bottom is performed. Thereafter, on both sides of the track widthwise direction (direction X) of the stacked layer body T1, the lower insulating layer 22, the hard bias layer 23, the upper insulating layer 24 are sequentially stacked from the bottom. In addition, on the protection layer 7 and the upper insulating layer 24r the upper shield layer 26 is formed.

As a method of manufacturing a tunnel type magnetic detection element shown in FIG. 2, a method which is similar to the method of manufacturing a tunnel type magnetic detection element shown in FIG. 1 can be used.

In this embodiment, at least a part of the second pinned magnetic layer 4c has a face centered cubic structure in which crystal planes equivalent to a (111) plane are aligned parallel to a layer surface. In more details, the second pinned magnetic layer 4c may be formed of Co₁₀₀₋ₓFeₓ (where the Fe composition ratio x is in the range of 0 at. % to about 20 at. %).

In this embodiment, the insulating barrier layer 5 may be formed of an insulating material such as titanium oxide having a rutile structure. Alternatively, the insulating barrier layer 5 may be formed of an insulating material having an amorphous structure, a body centered cubic structure, or a body centered tetragonal structure.

At least a part of enhance layer 6a formed on the insulating barrier layer 5 has a body centered cubic structure in which crystal planes equivalent to a (110) plane are aligned parallel to a layer surface. In more details, the enhance layer 6a is formed of Co_{100-y}Fe_{y} (where the composition ratio y of Fe is in the range of from about 30 at. % to 100 at. %), Co₂FeAl, Co₂FeSi, Co₂FeGa, Co₂FeGe, or Co₂Cr_{0.6}Fe_{0.4}Al.

As described above, by forming at least a part of the second pinned magnetic layer 4c under the insulating barrier layer 5 to have a face centered cubic structure in which crystal planes equivalent to a (111) plane are aligned parallel to a layer surface, a plane having a highest atomic packing density is aligned parallel to the layer surface, and it is difficult for the second pinned magnetic layer 4c to be oxidized or the like in a process for forming the insulating barrier layer 5.

In addition, by forming at least a part of the enhance layer 6a disposed on the insulating barrier layer 5 to have a body centered cubic structure in which crystal planes equivalent to a (110) plane are aligned parallel to a layer surface, the lattice matching on the boundary surface with the insulating barrier layer 5, which has a body centered cubic structure, a body centered tetragonal structure, or a rutile structure, is improved, and accordingly the enhance layer 6a may have an excellent crystallinity.

In addition, in a manufacturing process of the tunnel type magnetic detection element, thermal processes are performed. As described above, the thermal process for fixing the magnetization of the pinned magnetic layer 4 is a representative example of the thermal processes. By performing the aforementioned thermal processes, a crystallization state of the insulating barrier layer 5 may be improved, and accordingly lattice matching on a boundary surface of the insulating barrier layer with the enhance layer 6a, which is formed on the insulating barrier layer, may be improved more effectively.

As described above, according to an embodiment of a method of manufacturing a tunnel type magnetic detection element, the spin polarizations of both the second magnetic layer 4c and the enhance layer 6a which mainly contribute to the resistance change ratio (ΔR/R) may be improved appropriately. Accordingly, it is possible to manufacture a tunnel type magnetic detection element which has the small RA value and a high resistance change ratio (ΔR/R) appropriately and simply.

The tunnel type magnetic detection element according to the present embodiment can be used not only in a hard disk device but also as an MRAM (magnetic resistance memory).

A tunnel type magnetic detection element having a structure shown in FIG. 1 is formed. The configuration of a first basic layer of the stacked layer body T1 includes from the bottom a base layer of Ta (80), a seed layer of NiFeCr (50), an anti-ferromagnetic layer of IrMn (70), a pinned magnetic layer including a first pinned magnetic layer Of Co_{90at.%}Fe_{30at.%} (14), a non-magnetic intermediate magnetic layer of Ru (8.5), and a second pinned magnetic layer of Co_{90at.%}Fe_{10at.%}, an insulating barrier layer of Ti—O (14), a free magnetic layer including Co_{100-y}Fe_{y} (10) and NiFe (40), and a protection layer of Ta (200). Numbers in parentheses indicate depths of the layers in units of Å. As described above, the second pinned magnetic layer may be formed of Co₁₀₀₋ₓFeₓ, and the enhance layer constituting the free magnetic layer may be formed of Co_{100-y}Fe_{y}. The unit of the composition ratios (concentrations) x and y of Fe is at. %. The insulating barrier layer may be formed by forming a Ti layer and oxidizing the Ti layer.

In the experiment, tunnel type magnetic detection elements in which the composition ratio x of Fe in the second pinned magnetic layer and the composition ratio y of Fe in the enhance layer are changed variously based on the following configurations A, B, and C.

### (Composition A)

Tunnel type magnetic detection elements are formed in which the second pinned magnetic layers are formed of Co_{90at.%}Fe_{10at.%} fixedly and the Fe composition ratios y of Co_{100-y}Fe_{y} of the enhance layers are configured to be from 0 to 100 at. % by 10 at. %. respectively.

### (Composition B)

Tunnel type magnetic detection elements are formed in which the enhance layers are formed of Co_{50at.%}Fe_{50at.%} fixedly, and the Fe composition ratios x of Co₁₀₀₋ₓFeₓ of the second pinned magnetic layers are configured to be 20 at. %, 10 at. %, 30 at. %, and 50 at. %, respectively.

### (Composition C)

Tunnel type magnetic detection elements are formed in which the enhance layers are formed of Co_{90at.%}Fe_{10at.%} fixedly, and the Fe composition ratios x of Co₁₀₀₋ₓFeₓ of the second pinned magnetic layers are configured to be 20 at. %, 30 at. %, 40 at. %, 50 at. %, and 60 at. %, respectively.

The relationship between the RA value and the resistance change ratio (ΔR/R) and the crystal structures of the second pinned magnetic layer and the enhance layer of each tunnel type magnetic detection element are researched. The result is shown in FIG. 6.

As shown in FIG. 6, a tunnel type magnetic detection element included in the group A includes the second pinned magnetic layer (magnetic layer which is arranged under the insulating barrier layer) having a face centered cubic (fcc) structure and the enhance layer (magnetic layer which is arranged on the insulating barrier layer) having a body centered cubic (bcc) structure. A tunnel type magnetic detection element included in the group B includes the second pinned magnetic layer (magnetic layer which is arranged under the insulating barrier layer) having a body centered cubic (bcc) structure and the enhance layer (magnetic layer which is arranged on the insulating barrier layer) having a body centered cubic (bcc) structure. A tunnel type magnetic detection element included in the group C includes the second pinned magnetic layer (magnetic layer which is arranged under the insulating barrier layer) having a body centered cubic (bcc) structure and the enhance layer (magnetic layer which is arranged on the insulating barrier layer) having a face centered cubic (fcc) structure. A tunnel type magnetic detection element included in the group D includes the second pinned magnetic layer (magnetic layer which is arranged under the insulating barrier layer) having a face centered cubic (fcc) structure and the enhance layer (the magnetic layer which is arranged on the insulating barrier layer) having a face centered cubic (fcc) structure.

As shown in FIG. 6, it has been found that a group in which the RA value may decrease and the resistance change ratio (ΔR/R) may increase simultaneously is the group A. In other words, when the second pinned magnetic layer (magnetic layer which is arranged under the insulating barrier layer) is configured to be a face centered cubic (fcc) structure and the enhance layer (magnetic layer which is arranged on the insulating barrier layer) is configured to be a body centered cubic (bcc) structure, it has been found that the RA value can decrease and the resistance change ratio (ΔR/R) can increase simultaneously, more effectively.

From the experiment shown in FIG. 6, it has been found that the enhance layer can be formed to have a body centered cubic structure when the composition ratio y of Fe is configured to be in the range of 30 at. % to 100 at. % in forming the enhance layer, which is disposed on the insulating barrier layer with Co_{100-y}Fe_{y}.

And also, it has been found that the second pinned magnetic layer can be formed to have a face centered cubic structure when the composition ratio x of Fe is configured to be in the range of 0 at. % to 20 at. % in forming the second pinned magnetic layer, which is disposed under the insulating barrier layer with Co₁₀₀₋ₓFeₓ.

As in the Group A, by optimizing the crystal structures of the enhance layer and the second pinned magnetic layer, the RA value can decrease and the resistance change ratio (ΔR/R) may increase based on the following facts. In the second pinned magnetic layer which is formed under the insulating barrier layer, a (111) plane which has a highest atomic packing density and a face centered cubic structure is aligned parallel to a layer surface, and accordingly oxidation of the second pinned magnetic layer is hindered during formation of the insulating barrier layer. And also, when the enhance layer is formed to have a body centered cubic structure, the spin polarization can increase and the enhance layer suppresses the penetration of oxygen or the like through diffusion from the insulating barrier layer into the enhance layer and deterioration of the spin polarization of the enhance layer since a (110) plane having a highest atomic packing density in the body centered cubic structure is aligned.

Since the insulating barrier layer formed of titanium oxide has a rutile structure, the lattice matching on the boundary surface between the insulating barrier layer and the enhance layer is improved, so that the crystallinity of the enhance layer can be in an excellent state.

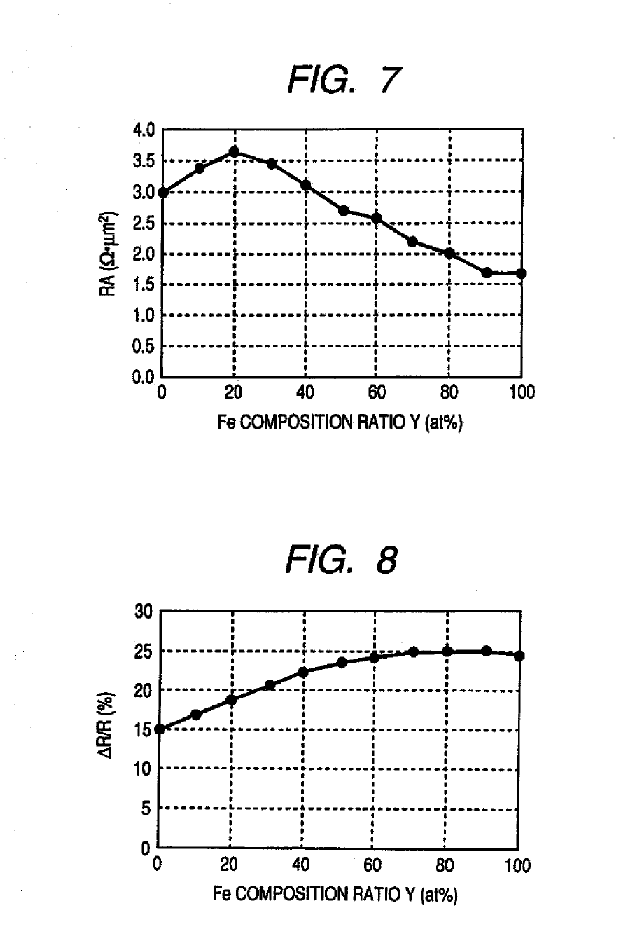

Next, in order to find a more preferable composition ratio y of Fe when the enhance layer formed on the insulating barrier layer is formed of Co_{100-y}Fe_{y}, tunnel type magnetic detection elements having the composition A are used, and the relationship between the composition ratio y of Fe and the RA value and the relationship between the composition ratio y of Fe and the resistance change ratio (ΔR/R) for each tunnel type magnetic detection element are researched. The results are shown in FIGS. 7 and 8.

As shown in FIG. 7, it has been found that when the composition ratio y of Fe becomes about 20 at. %, the RA value becomes a maximum and that as the composition ratio y of Fe is increased far above 20 at. %, the Ra value is decreased.

And also, as shown in FIG. 8, it has been found that as the composition ratio y of Fe is increased, the resistance change ratio (ΔR/R) increases.

From FIGS. 7 and 8, a preferable composition ratio y of Fe is configured in the range of 50 at. % to 100 at. %, and a more preferable composition ratio y of Fe is configured in the range of 70 at. % to 100 at. %.

Next, the resistance change ratio (ΔR/R) and magnetostriction of each tunnel type magnetic detection element which uses the basic layer configuration and has a following configuration of the free magnetic layer are obtained.

The structure of the free magnetic layer includes an enhance layer of Co_{90at.%}Fe_{10at.%}, a soft magnetic layer of Ni_{81.5at.%}Fe_{18.5%} (comparison example 1), an enhance layer of Co_{50at.%}Fe_{50at.%} and a soft magnetic layer of Ni_{81.5at.%}Fe_{18.5at.%} (embodiment 1), or an enhance layer of Co_{50at.%}Fe_{50at.%} and a soft magnetic layer of Ni_{86at.%}Fe_{14at.%} (embodiment 2).

In the comparison example 1, the composition ratios of Fe in the enhance layer (magnetic layer which is formed on the insulating barrier layer) and the second pinned magnetic layer (magnetic layer which is formed under the insulating barrier layer) are configured to be the same. Both the enhance layer and the second pinned magnetic layer have face centered cubic structures.

In the embodiments 1 and 2, the Fe composition ratios of the enhance layer (magnetic layer which is formed on the insulating barrier layer) is configured to be higher than that of the second pinned magnetic layer (magnetic layer which is formed under the insulating barrier layer). In both embodiments 1 and 2, the enhance layers have body centered cubic structures and the second pinned magnetic layers have face centered cubic structures. And also, the composition ratio of Ni in the embodiment 2 has a higher value than that in the embodiment 1.

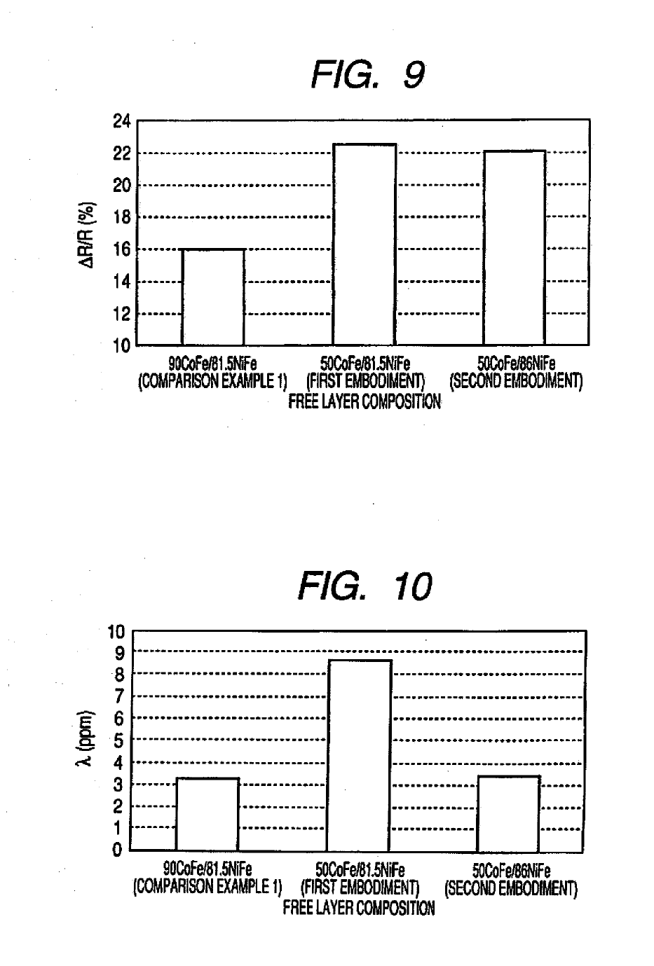

As shown in FIG. 9, it has been found that the resistance change ratio (ΔR/R) in the embodiments 1 and 2 is greater than that in the comparison example 1.

In addition, it has been found that, as shown in FIG. 10, the magnetostriction of the free magnetic layer has a small value in the comparison example 1 and the embodiment 2 and the magnetostriction of the free magnetic layer has a larger value in the embodiment 1.

It has found that the composition of the soft magnetic layer may be adjusted so as to increase the resistance change ratio (ΔR/R) and decrease the magnetostriction of the free magnetic layer, as shown in embodiment 2. In a CoFe alloy, when the Fe composition ratio is increased, the CoFe alloy has a large positive magnetostriction. The enhance layer of the present embodiment has a large positive magnetostriction. Accordingly, it has found that the absolute value of the magnetostriction of the free magnetic layer can be decreased by increasing the Ni composition ratio to make the magnetostriction of the soft magnetic layer negative when the soft magnetic layer is formed of a NiFe alloy as in the embodiment 2. In more details, when the Ni composition ratio is configured in the range of higher than 81.5 at. % and equal to or lower than 100 at. %, the soft magnetic layer can be configured to have a negative magnetostriction appropriately, and accordingly, the absolute value of the magnetostriction of the free magnetic layer can be decreased appropriately.

In addition, in the magnetostriction experiment of the free magnetic layer, a configuration in which the free magnetic layer is arranged on the insulating barrier layer is used. When the free magnetic layer is formed under the insulating barrier layer, the Fe composition ratio of the enhance layer constituting the free magnetic layer is originally configured to be low as a general case, so it may not be necessary to adjust the magnetostriction of the free magnetic layer by changing the composition of the soft magnetic layer.

The invention is not limited to the above-described embodiment but various changes and modifications thereof can be made. For example, the material or dimension of each layer in the present embodiment is only illustrative, but is not limited thereto. Therefore, modifications can be properly made without departing from the subject matter or spirit of the invention.

1. A tunnel type magnetic detection element comprising:
a lower magnetic layer, an insulating barrier layer, and an upper magnetic layer sequentially stacked from below,
wherein one of the magnetic layers forms at least a part of a pinned magnetic layer having a fixed magnetization and the other magnetic layer forms at least a part of a free magnetic layer having a magnetization that varies in accordance with an external magnetic field,
wherein at least a part of the lower magnetic layer has a face centered cubic structure in which crystal planes equivalent to a (111) plane are aligned parallel to a layer surface,
wherein at least a part of the insulating barrier layer has one of an amorphous structure, a body centered cubic structure, a body centered tetragonal structure, and a rutile structure, and
wherein at least a part of the upper magnetic layer has a body centered cubic structure in which crystal planes equivalent to a (110) plane are aligned parallel to a layer surface.

2. The tunnel type magnetic detection element according to claim 1, wherein at least a part of the insulating barrier layer has a rutile structure.

3. The tunnel type magnetic detection element according to claim 1, wherein the insulating barrier layer is formed of titanium oxide.

4. The tunnel type magnetic detection element according to claim 1, wherein the lower magnetic layer is formed of Co₁₀₀₋ₓFeₓ, x being in the range of from 0 at. % to about 20 at. %.

5. The tunnel type magnetic detection element according to claim 1, wherein the upper magnetic layer is formed of one of Co_{100-y}Fe_{y}, y being in the range of from about 30 at. % to 100 at. %, Co₂FeAl, Co₂FeSi, Co₂FeCa, Co₂FeGe, and Co₂Co_{0.6}Fe_{0.4}Al.

6. The tunnel type magnetic detection element according to claim 1, wherein the pinned magnetic layer is disposed under the insulating barrier layer, the pinned magnetic layer has a stacked layer ferri-structure in which a first pinned magnetic layer, a non-magnetic intermediate layer, and a second pinned magnetic layer are sequentially stacked from below and the second pinned magnetic layer contacts a bottom surface of the insulating barrier layer,
wherein the free magnetic layer is disposed on the insulating barrier layer and has a stacked layer structure including an enhance layer disposed on a top surface of the insulating barrier layer and a soft magnetic layer disposed on the enhance layer, and
wherein at least a part of the second pinned magnetic layer is disposed in the lower magnetic layer and at least a part of the enhance layer is disposed in the upper magnetic layer.

7. The tunnel type magnetic detection element according to claim 6, wherein the soft magnetic layer comprises a magnetostriction control region having a magnetostriction with a sign opposite to a magnetostriction of the upper magnetic layer.

8. The tunnel type magnetic detection element according to claim 7, wherein the upper magnetic layer is formed of a CoFe alloy, the magnetostriction control region is formed of Ni_{z}Fe_{100-z}, and z, a composition ratio of Ni, is formed to be higher than 81.5 at. % and equal to or lower than 100 at. %.

9. The tunnel type magnetic detection element according to claim 1, wherein the free magnetic layer is disposed under the insulating barrier layer and has a structure in which a soft magnetic layer and an enhance layer are sequentially stacked from below and the enhance layer contacts a bottom surface of the insulating barrier layer, and
wherein the pinned magnetic layer is disposed on the insulating barrier layer, the pinned magnetic layer has a stacked layer ferri-structure in which a second pinned magnetic layer contacting the top surface of the insulating barrier layer, a non-magnetic intermediate layer, and a first pinned magnetic layer are stacked sequentially from below, at least a part of the enhance layer is formed in the upper magnetic layer, and at least a part of the pinned magnetic layer is formed in the upper magnetic layer.

10. A method of manufacturing a tunnel type magnetic detection element, the method comprising the steps of:
(a) forming an upper magnetic layer, wherein at least a part of the upper magnetic layer has a face centered cubic structure in which crystal planes equivalent to a (111) plane are aligned parallel to a layer surface;
(b) forming an insulating barrier layer on the lower magnetic layer, wherein at least a part of the insulating barrier layer has one of an amorphous structure, a body centered cubic structure, a body centered tetragonal structure, and a rutile structure; and
(c) forming an upper magnetic layer on the insulating barrier layer, wherein at least a part of the upper magnetic layer has a body centered cubic structure in which crystal planes equivalent to a (110) plane are aligned parallel to a layer surface.

11. The method according to claim 10, wherein forming the insulating barrier on the lower magnetic layer comprises forming a metal layer or a semiconductor layer on the lower magnetic layer and oxidizing the metal layer or the semiconductor layer.

12. The method according to claim 11, wherein the metal layer is a titanium layer.

13. The method according to claim 10, wherein the lower magnetic layer is formed of Co₁₀₀₋ₓFeₓ, x being in the range of from 0 at. % to about 20 at. %.

14. The method according to claim 10, wherein the upper magnetic layer is formed of one of Co_{100-y}Fe_{y}, y being in the range of from about 30 at. % to 100 at. %, Co₂FeAl, Co₂FeSi, Co₂FeGa, Co₂FeGe, and Co₂Cr_{0.6}Fe_{0.4}Al.
